(19) United States
(12) Patent Application Publication
(10) Pub. No.: US 2013/0103744 A1
(43) Pub. Date: Apr. 25, 2013

(54) METHOD AND APPARATUS FOR EXECUTING WEB SERVICE PROGRAM BASED ON JAVASCRIPT

(71) Applicants: Ik-Soon KIM, Daejeon (KR); Chae-Deok Lim, Daejeon (KR)

(72) Inventors: Ik-Soon KIM, Daejeon (KR); Chae-Deok Lim, Daejeon (KR)

(73) Assignee: Electronics and Telecommunications Research Institute, Daejeon-city (KR)

(21) Appl. No.: 13/612,124

(22) Filed: Sep. 12, 2012

(30) Foreign Application Priority Data
Oct. 24, 2011 (KR) 10-2011-0109000
May 18, 2012 (KR) 10-2012-0053238

(51) Int. Cl. G06F 15/16

(52) U.S. Cl. 709/203

(57) ABSTRACT

Disclosed are a method for executing a JavaScript based web service program and an apparatus using the same. The method of executing a web service program based on JavaScript includes; selectively receiving initial transmission data among data about the web service program and libraries, which are used by the web service program, from a server by use of a predetermined reserved word; executing the web service program by use of the initial transmission data; if a JavaScript function that is not defined on the client device is going to be executed while the web service program is being executed, instantly sending the server a request signal requesting additional transmission data for the JavaScript function that is not defined on the client device; and receiving the additional transmission data from the server, and executing the web service program based on the initial transmission data and the additional transmission data.

### CROSS-REFERENCE TO RELATED APPLICATION

This application claims priorities to Korean Patent Applications No. 10-2011-0109000 filed on Oct. 24, 2011, and Korean Patent Application No. 10-2012-0053238 filed on May 18, 2012 which are incorporated herein by reference in its entirety.

### BACKGROUND OF THE INVENTION

1. Field of the Invention

Exemplary embodiments of the present invention relate to a method and an apparatus for executing a JavaScript-based web service program, in using a web service including JavaScript, by selectively downloading a part of the entire JavaScript, which is actually used for executing a JavaScript-based web service program, when required, instead of a conventional scheme of executing a JavaScript-based web service program by downloading the whole of a JavaScript library and a JavaScript program and executing a JavaScript-based web service program.

2. Description of Related Art

As World Wide Web (WWW) technologies have been developed in a rapid manner, many web standards (HTML5) have been newly suggested and established. The web standards established by W3C (World Wide Web Consortium) has suggested the JavaScript as a programming language for implementing a web service, and the JavaScript serves as an essential language for web services while being frequently used in implementing web services using the web standards.

In addition, with the development of web technologies, many programs have been written and executed as a web-based program in the form of a Software-As-A-Service (SaaS) that offers only a user-desired function among software functions, or in the form of a Platform-As-A-Service (PaaS) that provides a standardized platform by providing virtual hardwares and virtual softwares as required.

Such a web-based program has benefits that enable a user to easily use the latest software, without having to perform the complicated installation or maintenance process, and also provide a cross platform that enables the same services to be used on various operating systems and platforms associated with mobile devices in addition to desktop computers.

Such a web-based program is characterized in that the program is located on a remote server, and if required by a user, is downloaded to a client computer of the user for execution on the client computer.

Accordingly, the conventional web-based program is executed as follows. First, a program desired by a user and associated libraries that are to be used by the program are downloaded from a server to a client. After the associated libraries and the program are complete with transmission, the web-based program starts execution.

Meanwhile, the web-based programs have been developed so as to support more functions, increasing the complicacy in the structure of the program.

Therefore, the size of a code of the web-based programs is increased.

That is, with the increase of the size of the code of the web-based software, the time needed to download a web program through a network is increased, and thus the startup time for a web service is also increased.

U.S. Patent No. 2009-0070758 A1; METHOD AND SYSTEM FOR FAST RENDERING OF UNSIGNED APPLET JARS IN A WEB BROWSER ENVIRONMENT discloses a method of downloading a desired library at a later time when a number of Java libraries exist in the form of JAR files. However, JAVA is a different language from JavaScript, and the above method only discloses a structure of downloading a desired library at a later time without suggesting a solution to the problems associated with executing a JavaScript-based web service program.

### SUMMARY OF THE INVENTION

An embodiment of the present invention is to reduce the time required for downloading a JavaScript-based web service program, in executing the web-based program, by reducing the size of data being downloaded, and thus reduce the startup time of the web service program.

Other objects and advantages of the present invention can be understood by the following description, and will become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a method for executing a web service program based on JavaScript at a client device includes: selectively receiving initial transmission data from among data about the web service program and libraries, which are used by the web service program, from a server by use of a predetermined reserved word; executing the web service program by use of the initial transmission data; if a JavaScript function that is not defined on the client device is found while the web service program is being executed, instantly sending the server a request signal to request additional transmission data for the JavaScript function that is not defined on the client device; and receiving the additional transmission data from the server, and executing the web service program based on the initial transmission data and the additional transmission data.

In accordance with another embodiment of the present invention, an apparatus for executing a web service program based on JavaScript apparatus includes: a network interface unit configured to selectively receive initial transmission data from among data about the web service program and libraries, which are used by the web service program, from a sever by use of a predetermined reserved word; a JavaScript execution unit configured to execute the web service program by use of the initial transmission data; a control unit configured, if a JavaScript function that is not defined on a client device is found while the web service program is being executed, to control such that a request signal is instantly sent to the server to request additional transmission data for the JavaScript function that is not defined on the client device, the additional transmission data is received from the server, and the web service program is executed based on the initial transmission data and the additional transmission data.

### BRIEF DESCRIPTION OF THE DRAWINGS

FIG. 1 is a diagram illustrating a system for providing a web service program in accordance with an embodiment of the present invention.

FIG. 2 is a diagram illustrating conventional data transmission/reception between a server and a client device for executing a web service program.

FIG. 3 is a diagram illustrating data transmission/reception between a server and a client device in accordance with an embodiment of the present invention.

FIG. 4 is an operational flow chart illustrating a method for executing a JavaScript-based web service program in accordance with an embodiment of the present invention.

FIG. 5 is a diagram illustrating data of a JavaScript-based web service program in accordance with an embodiment of the present invention.

FIG. 6 is a diagram illustrating an apparatus for executing a JavaScript-based web service program in accordance with an embodiment of the present invention.

### DESCRIPTION OF SPECIFIC EMBODIMENTS

Exemplary embodiments of the present invention will be described below in a greater detail with reference to the accompanying drawings. In the description of the embodiments, it will be understood that the suffix of an element, such as “unit”, “device” and “apparatus”, is assigned for convenience of description and thus may be used together or in combination. In addition, “unit”, “device” and “apparatus” may be designed in hardwares or softwares.

Hereinafter, the embodiments of the present invention will be described with reference to the accompanying drawings and the contents illustrated in the drawings. However, the present invention is not limited to the embodiments described below, but can be implemented in various forms.

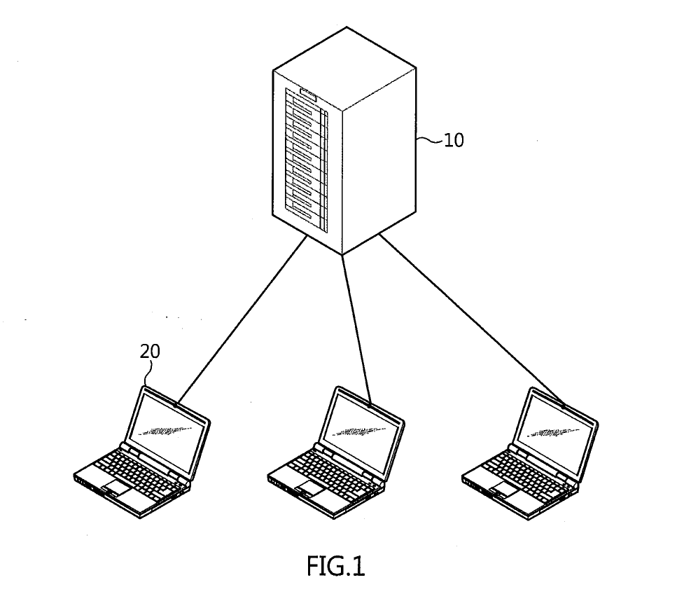

FIG. 1 is a diagram illustrating a system for providing a web service program in accordance with an embodiment of the present invention.

Referring to FIG. 1, a server 10 may store data about executing a web service program, and client devices 20 may access the server 10 to receive data needed for executing the program and perform an operation needed for executing the web service program.

In addition, a plurality of client devices may be connected to one server to execute various web service programs.

That is, the system for providing a web service program in accordance with the present invention includes a JavaScript-based web service program user, a server, a JavaScript-based web service program and libraries including JavaScript, the JavaScript-based web service program and the libraries stored in the server, and client devices that use the JavaScript-based web service program.

Hereinafter, the data transmission/reception between the server and the client devices will be described with reference to figures.

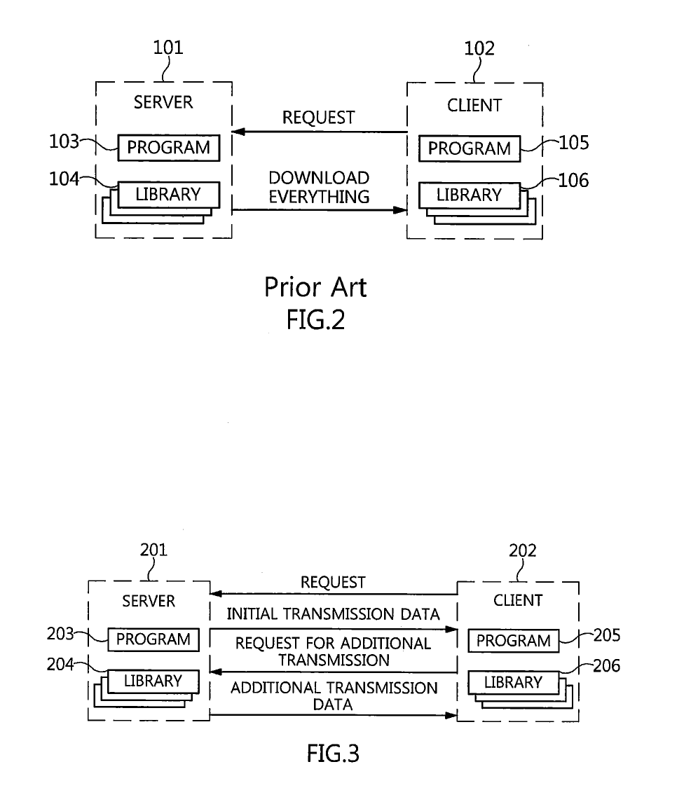

FIG. 2 is a diagram illustrating data transmission/reception between a server and a client device for executing a web service program.

For a server 101 and a client device 102 in executing a web service program in accordance with a conventional technology, if a program to be executed is determined by the client device 102, a request signal to request data needed for executing the determined program is sent to the server 101.

In addition, the server 101 may include a program data 103 and a library data 104 that are needed for executing the web service program. In response to a request signal of the client device 102, the whole of the program data 103 and the library data 104 are sent to the client device 102.

Accordingly, the client device 102 stores a transmitted program data 105 and a transmitted library data 106, and performs an operation needed for executing the web service program based on the stored data.

However, as such, even unnecessary data may be transmitted from the server 101 to the client device 102, thereby leading to inefficiency in the cost and time due to the transmission of unnecessary data.

In this regard, a web service program executing method with enhanced efficiency is suggested as illustrated in FIG. 3.

FIG. 3 is a diagram illustrating data transmission/reception between a server and a client device in accordance with an embodiment of the present invention.

JavaScript language has ‘function’, which is a ‘reserved’ word, and a JavaScript function may be defined by use of the ‘function’.

In accordance with the embodiment of the present disclosure, a server 201 may include a program data 203 and a library data 204 that are needed for executing a web service program. When initially transmitting a JavaScript program to the client device 202, initial transmission data may be selectively received from among data about the web service program and data about libraries, which are used by the web service program, by use of a predetermined reserved word.

In addition, if a certain undefined JavaScript function needs to be executed in the middle of executing the JavaScript-based web service program that is partly downloaded, the client device 202 sends the server 201 a request signal to request additional transmission data for the certain undefined JavaScript function.

The server 201, upon reception of a request regarding the certain undefined JavaScript function from the client device 202, sends the client device 202 additional transmission data for the certain undefined JavaScript function.

In addition, the client device 202 receives the requested JavaScript function from the server 201, and repeats requesting and receiving additional transmission data until the web service program is complete with execution.

In accordance with the present invention, downloading is performed only on a JavaScript 205 and a library 206, which correspond to an available part for executing a JavaScript-based web service program in practice, thereby preventing unavailable JavaScript program and libraries from being downloaded as a whole. Accordingly, the time to download a web service program can be reduced, the amount of data being downloaded can be reduced, and the startup time for the web service program can also be reduced.

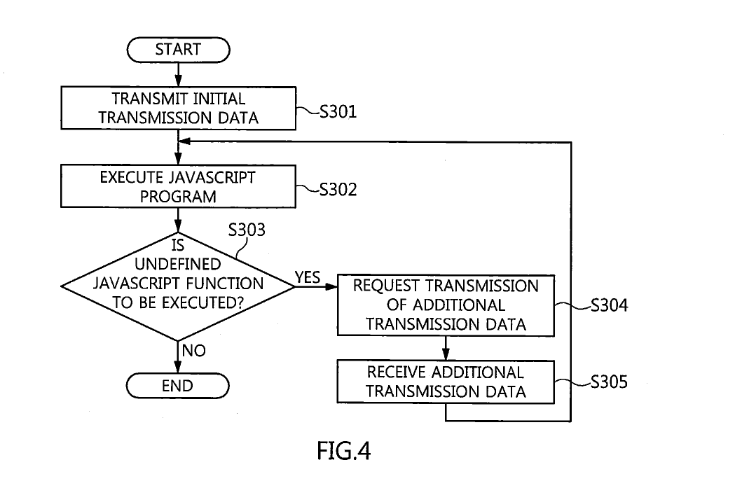

FIG. 4 is an operational flow chart illustrating a method for executing a JavaScript-based web service program in accordance with an embodiment of the present invention.

If a JavaScript-based web service program is requested for execution by the client device, the client device, by use of ‘function’ representing a predetermined reserved word, selectively receives initial transmission data from among data about the web service program requested for execution and data about libraries used by the web service program, in which the initial transmission data is data except for JavaScript functions that are defined by use of the ‘function’ (S301). Thereafter, the client device proceeds with execution of the web service program based on the received initial transmission data (S302).

That is, the client device may determine a server where a JavaScript-based web service program desired to be executed and data about the web service program are located, send the determined server a request signal for initial transmission data, and receive the initial transmission data.

Thereafter, in the middle of executing the web service program by use of the received initial transmission data alone, the client device determines whether a JavaScript function that is not defined on the client device is to be used (S303), and if determining to download an encountered JavaScript function that is not defined on the client device, the client device instantly sends the server a request signal (S304) to request additional transmission data for the JavaScript function that is not defined on the client device, in which the additional transmission data may be referred to as ‘first additional transmission data’.

Thereafter, the client device receives the first additional transmission data from the server (S305), and proceeds with the execution of the web service program based on the initial transmission data and the first additional transmission data.

While proceeding with execution of the web service program based on the initial transmission data and the first additional transmission data, if the client device finds a certain JavaScript function, which is not defined on the initial transmission and the first additional transmission data, the client device sends the server a request signal to request additional transmission data for the certain JavaScript function, in which the additional transmission data may be referred to as ‘second additional transmission data’, receives the second additional transmission data corresponding to the request signal, and proceeds with the execution of the web service program based on the initial transmission data, the first additional transmission data and the second additional transmission data.

That is, whenever a need occurs for a JavaScript function that is not defined on the client device, the client device sends the server a request signal for downing the JavaScript function, receives the corresponding function, and completes with the execution of the JavaScript program.

Meanwhile, in the middle of executing a web service program, the client device may be able to complete with the execution of the web service program without having to download unused JavaScript functions that are not defined on the client device, so that the amount of data being transmitted can be reduced.

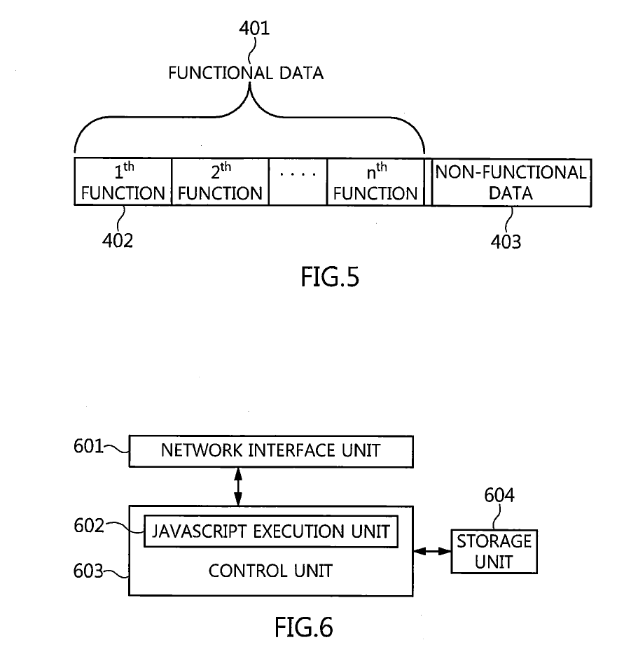

FIG. 5 is a diagram illustrating a conceptual data layout of a JavaScript-based web service program in accordance with an embodiment of the present invention.

In accordance with the present invention, data needed for executing a web service program stored in the server is conceptually divided as illustrated in FIG. 5.

That is, data needed for executing a JavaScript based web service program are conceptually divided into JavaScript functional data 401 and non-functional data 403, and the functional data 401 are divided according to functions 402.

Accordingly, a method and an apparatus for executing a JavaScript-based web service program in accordance with the embodiment of the present invention can receive data only for necessary JavaScript functions, so that the startup time can be reduced.

FIG. 6 is a diagram illustrating an apparatus for executing a JavaScript-based web service program in accordance with an embodiment of the present invention.

An apparatus for executing a JavaScript-based web service program in accordance with an embodiment of the present invention includes a network interface unit 601, a JavaScript execution unit 602, a control unit 603 and a storage unit 604.

The network interface unit 601, by use of a predetermined reserved word, may selectively receive initial transmission data from among data about the web service program and data about libraries, which are used by the web service program, from the server.

The reserved word is ‘function’, and the initial transmission data may include data except for JavaScript functions that are defined by use of ‘function’.

The JavaScript execution unit 602 may execute the web service program by use of the initial transmission data alone. That is, the JavaScript execution unit 602 may store basic data for executing the JavaScript and execute the web service program.

The control unit 603, if a JavaScript function that is not defined on the client device is going to be executed while the web service program is being executed, may control such that a request signal to request additional transmission data for the JavaScript function that is not defined on the client device is sent to the server, the additional transmission data is received from the server, and the web service program is executed based on the initial transmission data and the additional transmission data.

In addition, the control unit 603, if a JavaScript function that is not defined in the initial transmission data and the additional transmission data is going to be executed while the web service program is being executed based on the initial transmission data and the additional transmission data, may control such that a request signal to request additional transmission data for the JavaScript function that is not defined in the initial transmission data and the additional transmission data is sent to the server.

In addition, the control unit 603, if a JavaScript function that is not defined on the client device is not used while the web service program is being executed, may control such that the JavaScript execution unit proceeds to a complete state of the web service program to finish the execution without having to receive the unused JavaScript function.

In addition, the control unit 603, if a server having a JavaScript-based web service program desired to be executed at the apparatus and data about the web service program thereon is determined, may control such that a request signal for the initial transmission data is sent to the determined server.

The storage unit 604 may store data that are needed for executing the JavaScript based-web service programs.

In accordance with the exemplary embodiments of the present invention, the method and the apparatus for executing a JavaScript-based web service program in accordance with the present invention can reduce the size of the downloading data of a web based program, so that the time for downloading can be reduced and the startup time for a web service program can also be reduced.

While the present invention has been described with respect to specific embodiments thereof, it will be apparent to those skilled in the art that various changes and modifications may be made without departing from the spirit and scope of the invention as defined in the following claims.

What is claimed is:

1. A method for executing a web service program based on JavaScript at a client device, the method comprising:
selectively receiving initial transmission data among data about the web service program and libraries, the libraries used by the web service program from a server by use of a predetermined reserved word;
executing the web service program by use of the initial transmission data;
if a JavaScript function that is not defined on the client device is going to be executed while the web service program is being executed, instantly sending the server a request signal to request additional transmission data for the JavaScript function that is not defined on the client device; and
receiving the additional transmission data from the server, and executing the web service program based on the initial transmission data and the additional transmission data.

2. The method of claim 1, wherein the reserved word is a word ‘function’, and the initial transmission data is data except for JavaScript functions defined by the reserved word.

3. The method of claim 1, further comprising, if a JavaScript function that is not defined in the initial transmission data and the additional transmission data is going to be executed while the web service program is being executed based on the initial transmission data and the additional transmission data, sending the server a request signal to request additional transmission data for the JavaScript function that is not defined in the initial transmission data and the additional transmission data.

4. The method of claim 1, wherein the sending the server the request signal comprises:
if a JavaScript function that is not defined on the client device is not used while the web service program is being executed, proceeding with the execution of the web service program to a completion state to finish the execution of the web service program without having to download the JavaScript function.

5. The method of claim 1, further comprising:
determining a server that has the web service program which is desired to be executed and data about the web service program thereon; and
sending the determined server a request signal to request the initial transmission data.

6. An apparatus for executing a web service program based on JavaScript, the apparatus comprising:
a network interface unit configured to selectively receive initial transmission data among data about the web service program and libraries, which are used by the web service program from a sever by use of a predetermined reserved word;
a JavaScript execution unit configured to execute the web service program by use of the initial transmission data;
a control unit configured, if a JavaScript function that is not defined on a client device is going to be executed while the web service program is being executed, to control such that a request signal is instantly sent to the server to request additional transmission data for the JavaScript function that is not defined on the client device, the additional transmission data are received from the server, and the web service program is executed based on the initial transmission data and the additional transmission data.

7. The apparatus of claim 6, wherein the reserved word is a word ‘function’, and the initial transmission data are data except for JavaScript functions that are defined by the reserved word.

8. The apparatus of claim 6, wherein the control unit, if a JavaScript function that is not defined in the initial transmission data and the additional transmission data is going to be executed while the web service program is being executed based on the initial transmission data and the additional transmission data, controls such that a request signal is sent to the server so as to request additional transmission data for the JavaScript function that is not defined in the initial transmission data and the additional transmission data.

9. The apparatus of claim 6, wherein the control unit, if a JavaScript function that is not defined on the client device is not used while the web service program is being executed, controls such that the JavaScript execution unit proceeds with the execution of the web service program to a completion state to finish the execution of the web service program, not needing to download the JavaScript function.

10. The apparatus of claim 6, wherein the control unit, upon determination of a server that has the web service program desired to be executed by the JavaScript execution unit and data about the service program thereon, controls such that a request signal is sent to the determined server so as to request the initial transmission data.
